(19) United States
(12) Patent Application Publication
(10) Pub. No.: US 2019/0259020 A1
(43) Pub. Date: Aug. 22, 2019

(54) ENROLLMENT SERVER

(71) Applicants: Patrick Faith, Pleasanton, CA (US); Ayman Hammad, Pleasanton, CA (US); Jack Coyne, San Mateo, CA (US)

(72) Inventors: Patrick Faith, Pleasanton, CA (US); Ayman Hammad, Pleasanton, CA (US); Jack Coyne, San Mateo, CA (US)

(21) Appl. No.: 16/283,547

(22) Filed: Feb. 22, 2019

Related U.S. Application Data
(63) Continuation of application No. 12/581,753, filed on Oct. 19, 2009, now abandoned.
(60) Provisional application No. 61/170,544, filed on Apr. 17, 2009.

(51) Int. Cl. G06Q 20/32; G06Q 40/00; G06Q 40/02; G06Q 30/02; G06Q 20/00; G06Q 20/40

(52) U.S. Cl. CPC G06Q 20/3255; G06Q 40/12; G06Q 40/02; G06Q 20/405; G06Q 20/00; G06Q 20/4016; G06Q 20/3223; G06Q 30/0201

(57) ABSTRACT

Systems, methods and apparatus for processing enrollment requests are provided. Enrollment requests may be sent from a user to an enrollment server. The enrollment server may verify the information in the enrollment request with entities that may contain authoritative data reflecting the validity of the information in the enrollment request. The authenticity of devices involved in the enrollment request may also be verified. In addition, the user's transaction history can be reviewed to determine if the enrollment fits the user's transaction history profile. Based on the verified information and a level of risk associated with the enrollment, the enrollment server may allow or deny the enrollment request.

### CROSS REFERENCE TO RELATED APPLICATIONS

This application is a non-provisional of and claims the benefit of U.S. Patent Application Ser. No. 61/170,544 (Attorney Docket 016222-042900US) filed on April 17, 2009, which is herein incorporated by reference in its entirety for all purposes.

### BACKGROUND

Embodiments of the present application relate to systems and methods of enrolling for services. More specifically, embodiments of the present application relate to verifying enrollment information against several data sources and historical behavior of the enrollee and persons associated with the enrollee.

There are many different services offered to consumers that require the consumer to enroll in order to receive benefits. One example of such a service is a notification service that allows a credit card holder to be sent a text message on his cell phone whenever the credit card is used to perform a transaction. The text message can include details such as the time, place, and amount of a transaction. Such a service can be useful to a cardholder to determine if his card is being used fraudulently. Furthermore, in situations where additional parties, such as employees or children of the card holder, are also authorized to use the cardholder's account, such notifications are useful for monitoring the additional user's behavior.

A problem that can arise with enrollment in a notification service as described above is that the entity providing the service is not able to verify all the information necessary to ensure that only authorized persons are enrolling. For example, a fraudulent user may obtain information regarding a credit card account, including an account number, card holder name, address, etc. The fraudulent user may then use this information to enroll the account for notification services, with notification to be provided to the fraudulent user's cellular phone. The fraudulent user may use this information for nefarious purposes. For example, if the fraudulent user notices a large number of transactions are being performed out of the country, he may surmise that the cardholder is not at home, and it would be an opportune time to rob the cardholder's home.

Typically, an enrollment process may be able to verify some information, such as the account number and cardholder's address, however there will be additional information necessary for enrollment that will not be available to the entity performing the enrollment. A fraudulent user may use this information gap to perform actions that are adverse to intended beneficiaries of the services.

Therefore, what is needed is an enrollment server and method of using the enrollment server that can verify an enrollee's enrollment information such that only authorized persons are allowed to enroll for services, using properly verified devices.

Embodiments of the present disclosure attempt to solve these and other problems individually and collectively.

### BRIEF SUMMARY

Embodiments of the present disclosure provide systems, methods, and apparatus for processing enrollment requests. In one embodiment, an enrollment server comprising a processor is provided. The processor is coupled to a memory. The memory includes computer code for receiving an enrollment request at the enrollment server, the request including information identifying the requestor. The memory also includes computer code for sending at least a first portion of the identifying information to a first verifying entity and computer code for sending at least a second portion of the identifying information to a second verifying entity. Additionally, the memory includes computer code for receiving from the first verifying entity a first indication of the first portion of identifying information matching identifying information stored by the first verifying entity and computer code for receiving from the second verifying entity a second indication of the second portion of identifying information matching identifying information stored by the second verifying entity. Furthermore, the memory includes computer code for comparing the enrollment request with a requestor's transaction history, the comparison indicating a degree to which the enrollment request matches the requestor's transaction history. The memory also includes computer code for allowing or denying the enrollment request based on the first indication, the second indication, and the degree to which the enrollment request matches the requestor's transaction history.

In another embodiment, a computer implemented enrollment method is provided. The method comprises receiving an enrollment request at an enrollment server, the enrollment request including information that identifies the requestor. The method further includes sending at least a first portion of the identifying information to a first verifying entity and sending at least a second portion of the identifying information to a second verifying entity. The method additionally includes receiving from the first verifying entity a first indication of the first portion of identifying information matching identifying information stored by the first verifying entity and receiving from the second verifying entity a second indication of the second portion of identifying information matching identifying information stored by the second verifying entity. Furthermore, the method includes comparing the enrollment request with a requestor's transaction history. The method also includes allowing or denying the enrollment request based on the first indication, the second indication, and the comparison of the requestor's transaction history.

In yet another embodiment, a computer implemented method of enrolling is provided. The method includes sending an enrollment request to an enrollment server. The enrollment request includes information identifying the requestor. The enrollment server is configured to receive the enrollment request. The enrollment server is further configured to send at least a first portion of the identifying information to a first verifying entity and send at least a second portion of the identifying information to a second verifying entity. The enrollment server is further configured to receive from the first verifying entity a first indication of the first portion of identifying information matching identifying information stored by the first verifying entity and receive from the second verifying entity a second indication of the second portion of identifying information matching identifying information stored by the second verifying entity. The enrollment server is also configured to compare the enrollment request with a requestor's transaction history. The comparison indicates the degree to which the enrollment request matches the requestor's transaction history. The enrollment server is further configured to allow or deny the enrollment request based on the first indication, the second indication, and the degree to which the enrollment request matches the requestor's transaction history. The method also includes receiving an enrollment response that indicates if the enrollment is allowed or denied.

These and other embodiments of the disclosure are described in further detail below with reference to the figures and the detailed description.

### BRIEF DESCRIPTION OF THE DRAWINGS

FIG. 1 depicts an exemplary system according to an embodiment of the disclosure.

FIG. 2 depicts a high level flow diagram of an enrollment process in accordance with one embodiment of the disclosure.

FIG. 3 depicts an exemplary user interface for enrollment requests.

FIG. 4 depicts an exemplary household relationship.

FIG. 5 depicts typical components or subsystems of a computer apparatus.

FIG. 6 depicts a portable consumer device.

### DETAILED DESCRIPTION

Embodiments of the present disclosure provide systems and methods for enrolling a user for one or more services. As part of the enrollment process, the user may provide certain information identifying himself and/or the device that is being used to perform the enrollment. The user may also provide information identifying the device that is being enrolled. The identification and device information may be compared with multiple verifying entities and databases to determine if the information provided is consistent with information already of record for the user. Additionally, the enrollment request can also be compared to the transaction history of the user, to determine if the particular enrollment matches the types of transactions performed by the user. The comparison of identifying information and transaction histories may also be extended to members of the user's household.

I. Exemplary System

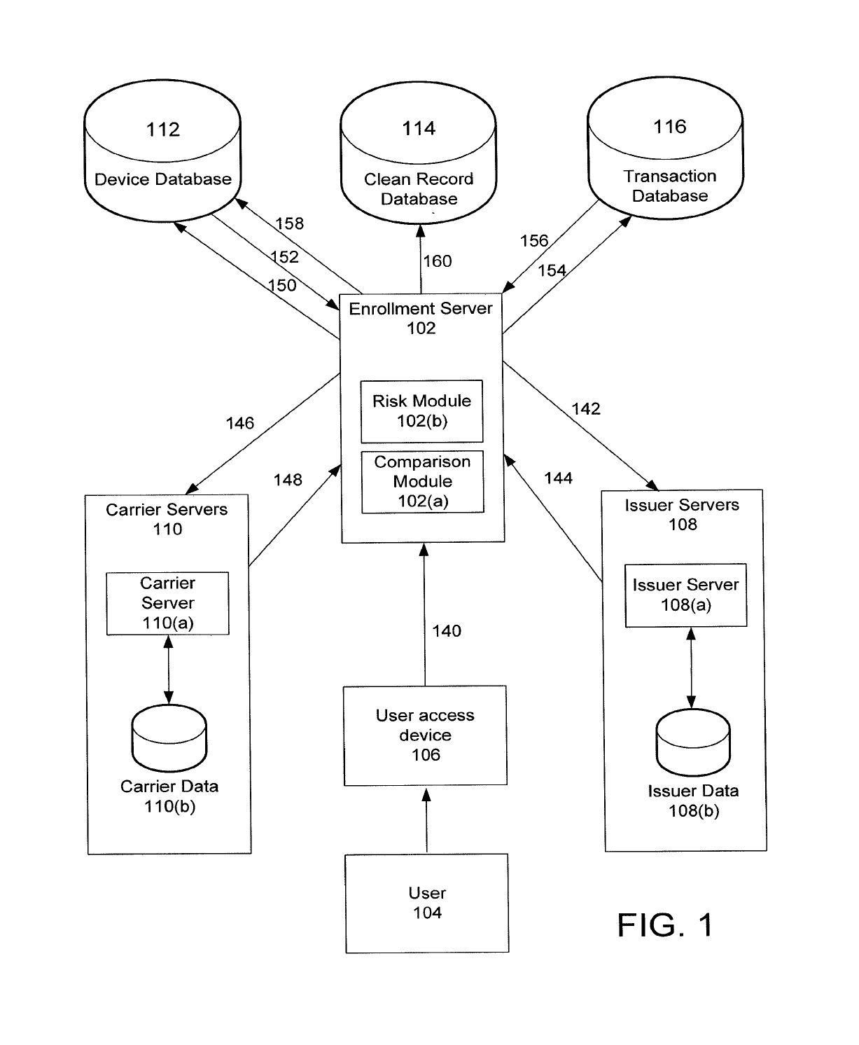

FIG. 1 depicts an exemplary system 100 according to an embodiment of the disclosure. Other systems according to other embodiments of the disclosure may include more or less components than are shown in FIG. 1.

System 100 shown in FIG. 1 includes an enrollment server 102. Enrollment server 102 may be used to enroll a user 104 for a variety of services. In a typical enrollment transaction, a user 104 may use a user access device 106 to access the enrollment server 102 to enroll for services. The enrollment server 102 may communicate with one or more issuer systems 108 in order to verify a user's 104 identity and eligibility to enroll in the desired services. The enrollment server 102 may also be in communication with one or more carrier systems 110 in order to further verify a user's 104 identity and eligibility to enroll in the desired services. System 100 may also include a device database 112 in communication with the enrollment server 102. Device database 112 may store information identifying devices, such as user access device 106, that are enrolled or used to enroll for services. System 100 may also include a transaction database 116 that may be used to store a transaction history of transactions performed by user 104. A clean record database 114 may also be included in system 100 to store information about the user 104 that has been verified and determined to be accurate. System 100 may also provide external access to clean record database 114.

A user 104 may desire to enroll in one or more services. Typically, services may be offered by a variety of sources. One exemplary provider of services could be a payment processing network operated by Visa™. The Visa™ network offers a wide variety of services to holders of Visa™ branded transaction accounts. Some examples of these services include account holder transaction notification via e-mail or text message, fund transfer services, coupon services, or any other suitable service. In order to gain the benefit of such services, a user will typically be required to enroll his transaction account for the service. Although this exemplary embodiment is presented in terms of a payment processing network offering services, it should be clear that embodiments of the disclosure are applicable to any service from any provider that requires the service recipient to enroll.

The user 104 may use a user access device 106 to enroll for a service. In some embodiments, the user access device 106 may be a personal computer running a web browser. The user 104 may point his user access device 106 to an enrollment web page provided by an enrollment server 102. The enrollment web page may prompt the user to enter information necessary to process the service enrollment. Although a personal computer is one example of a suitable user access device 106 any other type of access device can be used in various embodiments. Additional examples of user access devices 106 could include cellular telephones, personal digital assistants, and standard telephones, using either automated response systems or a human operator receiving details necessary for enrollment. Any device that allows a user to convey enrollment information to an enrollment server 102 may be suitable as a user access device 106.

Enrollment server 102 may process a request from a user 104 to enroll for a service. The enrollment request may include information identifying the user 104 and the service he is attempting to enroll in. For example, a user 104 may be enrolling in a service that provides text message notifications to his cellular telephone whenever his transaction account is used to perform a transaction. The user 104 may include information such as his name, billing address, transaction account number, expiration date, and cellular telephone number in the enrollment request. In some embodiments, enrollment server 102 comprises a comparison module 102(a) and a risk module 102(b). Comparison module 102(a) may be used to verify the accuracy of the information provided by the user 104 in the enrollment request, while risk module 102(b) may be used to determine the level of risk associated with an enrollment request.

In one embodiment, user 104 may be enrolling in services for a transaction account. Typical examples of transaction accounts can include debit, credit, and pre-paid accounts. In some embodiments, a transaction account may be associated with a physical card, such as a credit card. Other embodiments may use an account identifier without a physical representation of the transaction account. A transaction account may typically be issued by an issuer system 108 which can be referred to as an issuer. An issuer 108 can be a business entity, such as a bank, that issues transaction accounts. Issuer systems 108 may comprise one or more server computers 108(a) and may further comprise an issuer database 108(b). Issuer database 108(b) may store information regarding the user 104 and any accounts that have been issued by the issuer system 108. Examples of such information may include names, billing addresses, account numbers, and telephone numbers.

The issuer database 108(b) may contain information that is both authoritative and non-authoritative. Authoritative information may be information that can be considered to be factually true because the issuer system 108 is the entity best able to verify the information. For example, an issuer 108 may be able to verify a transaction account number with authority, because the issuer system 108 issued the transaction account number. The issuer database 108(b) may also contain information that is non authoritative, such as a telephone number associated with the holder of a transaction account. Because a telephone number was not issued by the issuer system 108, and was most likely received at some point from the user, the issuer system 108 can not be certain the telephone number is correct.

In one embodiment, system 100 may further include a secondary verifying entity, such as a carrier system 110 which can also be referred to as a carrier. An exemplary carrier 110 may be the telecommunications carrier that provides cellular telephone service to the user 104. A carrier system 110 may comprise one or more server computers 110(a) and may further comprise a carrier database 110(b). As with the issuer system 108, carrier database 110(b) may store information regarding the user 104 and any telecommunications devices, such as cellular phones, provided by the carrier 110. Examples of such information can include names, billing addresses, and telephone numbers.

Just as with issuer database 108(b), carrier database 110(b) may contain information that is authoritative as well as information that is non-authoritative. For example, the telephone number of the user's 104 cellular telephone may be authoritative information, because the carrier 110 is the entity that provided the telephone number and is in the best position to verify the accuracy of the telephone number. Examples of non-authoritative information that may be maintained by carrier database 110(b) could include any other information that is not directly associated with the service carrier 110 provides.

Although the secondary verifying authority in an exemplary embodiment is a carrier 110, embodiments of the disclosure are not so limited. Any entity that may contain authoritative information about a user 104 may also be used. Some examples of such entities can include merchant systems, government systems, or any other systems that maintain authoritative information about a user 104. Furthermore, although system 100 depicts a single issuer 108 and carrier 110, embodiments are not so limited. It should be clear that there may be any number of issuer systems 108 and other systems, such as carrier systems 110, that contain authoritative information about a user 104.

In one embodiment, system 100 may further include a device database 112. Device database 112 may be used to store information related to various user access devices 106 that may be used by the user 104 to enroll in services or to receive services. For example, a user 104 may enroll in a service using his personal computer. Information about the personal computer, such as its IP address, MAC address, or other identifying information may be stored in device database 112. As another example, a user may be enrolling in a cellular telephone text message transaction notification service. Information about the user's 104 cellular telephone, such as the phone number, the electronic serial number, or other identifying information may be stored in device database 112.

In one embodiment, system 100 may further include a clean record database 114. Clean record database 114 may be used to store information about a user 104 that has been verified by entities such as the issuer 108 and carrier 110. As will be explained in further detail below, enrollment server 102 may receive an enrollment request from a user 104 containing identifying information. Enrollment server 102 may then verify this information using verifying entities that contain authoritative information regarding the accuracy of the identifying information. As such, enrollment server 102 may have the most complete information about a user 104, because it has been verified through authoritative verifying entities. This information may be stored to provide the most accurate profile of a user 104. In some embodiments, an external interface (not shown) may be provided to external systems to allow access to the clean records database. For example, as discussed above, an issuer 108 may contain authoritative data about a user's 104 transaction account identifier, but may not necessarily have an accurate phone number for the user 104. By accessing clean record database 114, the issuer 108 may be able to update its records to reflect the most accurate information about the user 104, even though the issuer 108 is not the authoritative source for all of the information.

In one embodiment, system 100 may further include a transaction database 116. Transaction database 116 may be used to store all transactions a user 104 may perform with his transaction account that was issued by issuer 108. Transactions may include purchases, cash advances, loans, balance transfers, or any other type of transaction that may be performed with a transaction account. In some embodiments, transactions may be stored for extended periods of time, such as the last seven years. Transaction database 116 may be used by enrollment server 102 to further verify enrollment requests, as will be explained below.

Transaction database 116 may receive transaction information from a payment processing system. The payment processing system may include data processing subsystems, networks, and operations used to support and deliver authorization services, exception file services, and clearing and settlement services. An exemplary payment processing system may include VisaNet™. Payment processing systems such as VisaNet™ are able to process credit card transactions, debit card transactions, and other types of commercial transactions. VisaNet™, in particular, includes a single message system (SMS) that automatically authorizes and provides enough information to automatically clear and settle a financial transaction, and/or a VIP system (Visa Integrated Payments system) which processes authorization requests and a Base II system, which performs clearing and settlement services.

Transaction database 116 may not be limited to storing transactions performed using transaction accounts issued by a single issuer 108. Because a payment processing system such as VisaNet™ processes transactions from many issuers, transactions performed by a user 104 using accounts issued by multiple issuers may all be stored in transaction database 116. Furthermore, because a payment processing system such as VisaNET™ is responsible for processing transactions in real time, the payment processing network may be able to update transaction database 116 in real or near real time. Transaction processing that may be performed by other entities, such as issuers or credit rating agencies may occur on a daily or monthly basis, and as such may not be able to update transaction database 116 with the most up to date transactions. In some embodiments, transaction database 116 may be advantageously updated with transaction information within a period of five minutes from when the transaction occurred. In other embodiments, transaction database 116 may be populated with transaction information from any source that processes transactions.

II. Exemplary Method

An exemplary enrollment process may begin with a user 104 deciding to enroll for a service. One example of such a service would be cellular telephone text message notifications of all transactions associated with the user's credit card. Although this example is presented as relating to enrollments for services related to transaction accounts, embodiments of the disclosure are not limited to transaction account related enrollments. Any other type of service which requires enrollment is contemplated.

The user 104 may use a user access device 106 in order to enroll for the desired service. For example, the user 104 may use a personal computer running a web browser as the user access device 106. The user 104 may direct his access device 106 to the enrollment server 102 of the entity offering the service, for example by pointing his web browser to a web site hosted by the enrollment server 102. As part of the enrollment process, the user 104 may provide information necessary to enroll in the service to the enrollment server 102 in an enrollment request 140. Examples of such information can include a transaction account identifier, a billing address, a transaction account expiration date, a cellular telephone number, or any other information necessary to enroll the user 104 for a service.

Enrollment server 102 may receive the enrollment request 140 from the user 104. Using comparison module 102(a), enrollment server 102 may verify the information provided by user 104 in the enrollment request with one or more verifying entities. Verifying entities may include issuer systems 108 and carrier systems 110. Comparison module 102(a) may send 142 portions of the information provided in the enrollment request 140 to an issuer server 108(a) for verification. In some embodiments, only portions of the enrollment request that can be verified with authority are sent 142 to the issuer server 108(a). For example, a user's transaction account identifier, expiration date, and billing address may be information that an issuer server 108(a) can verify with authority. Issuer server 108(a) may then query an issuer database 108(b) to verify the information in the verification request 142. If issuer server 108(a) determines the information in the request is valid, a verification response 144 may be returned to the comparison module 102(a) which includes an indication that the information has been verified. In some embodiments, the verification response 144 may include indications that only certain portions of the information were verified. For example, issuer server 108(a) may be able to verify that a transaction account identifier and expiration date is valid, but the billing address provided in the verification request 142 is not valid.

Comparison module 102(a) may also send portions of the information provided in the enrollment request 140 to a second verifying entity, such as a carrier server 110(a). The second verification request 146 may contain portions of the information provided in the enrollment request 140 that can be verified with authority by the second verifying entity 110. For example, a user enrolling for text messages to be sent to his cellular telephone may provide his name and cellular telephone number in the enrollment request 140. This information may be sent to a carrier server 110(a). Carrier server 110(a) may query a carrier database 110(b) to verify the information provided. Carrier server 110(a) may provide a second verification response 148 to comparison module 102(a) which includes an indication that the information has been verified. In some embodiments, the verification response 148 may include indications that only certain portions of the information were verified. For example, carrier server 110(a) may be able to verify that a cellular telephone number is valid, but the name provided in the second verification request 146 is not valid.

Although this exemplary embodiment describes two verification entities, it should be clear that verification by any number of entities has been contemplated. For example, comparison module 102(a) may send verification requests to as many different entities as are required to verify all the information provided in the enrollment request 140. Furthermore, in some embodiments, the verification requests 142, 146 may not be sent sequentially, but rather occur in parallel.

Comparison module 102(a) may receive verification response 146, 148 to determine if the information provided in the enrollment request 140 is valid. Furthermore, comparison module 102(a) may query 150 a device database 112 to determine if the user access device 106 or the device, such as a cellular telephone, that is being enrolled for a service currently exists and is associated with the user 104. Device database 112 may send a response 152 to comparison module 102(a) indicating if a matching record was found in the device database 112.

Based on the verification responses 146, 148 and the device database response 152, comparison module 102(a) may evaluate if the information in the enrollment request is valid. In some embodiments, comparison module 102(a) may provide information regarding the extent to which information in the enrollment request has been verified to a risk module 102(b).

Risk module 102(b) may receive as input the evaluation performed by comparison module 102(a). Risk module 102(a) may determine the level of risk involved in allowing the enrollment request 140. Enrollment requests 140 for services that have a low potential of adverse impact on the service provider may be allowed even if the enrollment information can not be completely verified. For example, an enrollment request 140 for a service that issues discount coupons for purchases at a merchant may be allowed even if comparison module 102(a) is unable to verify the information provided by the user 104. The reason for this may be that the merchant is still being paid even if the coupon user is a fraudulent user. As another example, an enrollment request 140 for a service involving funds transfers from one account to another account may not be allowed unless every piece of information in the enrollment request 140 is verified by comparison module 102(a). In this example, if a fraudulent user is allowed to enroll his own account to receive funds from a valid user, the service provider may be forced to reimburse the valid user. Risk module 102(b) may use any number of criteria to determine exactly how much of the enrollment request 140 information must be verified before allowing the user 104 to enroll in the service.

In addition to determining how much of the enrollment request 140 information must be verified before allowing an enrollment for a service, risk module 102(b) may also evaluate a given enrollment request 140 with respect to transactions that have been performed by the user 104 in the past to determine if this enrollment request 140 fits the profile of the user 104. Risk module 102(b) may send a query 154 to transaction database 116 to obtain a transaction history of user 104. Transaction database 116 may send a response 156 to risk module 102(b) with transactions performed by the user 104. Using the transaction information 156 risk module 102(b) may determine the level of risk involved in allowing the enrollment request 140 given the user's 104 transaction profile. For example, if a user's transaction history shows that the user 104 has never performed a balance transfer in the past, but is enrolling for a balance transfer service, risk module 102(b) may not allow the enrollment request to proceed.

In some embodiments, risk module 102(b) may evaluate all the data received in responses 144, 148, 152, and 156 together to determine if a transaction should be allowed. For example, a user 104 may be enrolling for a service that delivers text message notifications of transaction account activity to his cellular phone. Comparison module 102(a) may determine that the user is performing this transaction from a user access device 106 that is not contained in the device database 112. Comparison module 102(a) may also determine that the cellular telephone being enrolled for the notification system also does not exist in the device database 112, but the telephone number and name were verified by carrier 110. Comparison module 102(a) may also determine that the transaction account identifier and name were verified by the issuer 108. This information may be provided to risk module 102(b). Risk module 102(b) may determine that user 104 has recently purchased a new cellular telephone based on his transaction history from transaction history database 116.

In some embodiments, risk module 102(b) may use all the data received in responses 144, 148, 152, and 156 together to calculate a risk score. In one embodiment, risk module 102(b) may assign a numerical value to each response received, with a higher value being assigned for responses that indicate a greater potential for fraud. For example, an issuer 108 response that verifies an account number and a billing address may be assigned a lower risk value than an issuer 108 response that was only able to verify the account number. The numerical values from all of the responses may be aggregated to produce a risk score. Enrollments whose aggregated risk score exceed a defined threshold may be denied. In other embodiments, the risk score may be reversed, such that the higher the risk for fraud, the lower the numerical value of the assigned risk. In such embodiments, only aggregated risk scores that are above a defined threshold may be allowed.

Based on this complete picture of the enrollment request 140, risk module 102(b) may determine that the risk involved in allowing this enrollment is minimal because the account identifiers and cellular telephone numbers were verified. Because the transaction history shows the user 104 recently purchased a cellular telephone, this may explain why the cellular telephone does not appear in the device database 112. Likewise, the user access device may not appear in the device database because the transaction history may show the user 104 has recently purchased a new access device or has changed access providers. As mentioned above, because transaction history database 116 may be updated in real or near real time, the most recent user transactions may be used in evaluating the user's transaction history. The criteria used by risk module 102(b) to allow or deny an enrollment request can be based on the level of risk associated with allowing a fraudulent enrollment. As the level of risk increases, the accuracy required of the supplied data may also increase.

Once risk module 102(b) has made a determination that an enrollment request should be allowed, risk module 102(b) may also update 158 device database 112 to add the user access device 106 and the cellular telephone. Because the information has been sufficiently verified by the enrollment server 102, the device information may be considered accurate. Furthermore, enrollment server 102 may also create or update 160 a clean record for the user in the clean records database 114. A clean record may include all information known by enrollment server 102 about user 104 that has been verified by entities that contain authoritative information about the user 104. For example, if an enrollment request 140 includes a transaction account identifier, a name, and a cellular telephone number, and the account identifier and name have been verified by an issuer, and the cellular telephone number and name have been verified by a carrier 110, enrollment server 102 may store 160 this information in clean record database 114.

Although not shown, an external interface to clean record database 114 may be provided to issuers 108, carriers 110, or any other entity that requires accurate identifying information about the user 104. For example, although the issuer may not require an accurate cellular telephone number for a transaction account, it would be desirable for the issuer to have the most up to date information. A user may purchase a new cellular telephone and may forget to inform the issuer that he has a new telephone number. With access to clean records database 114, the issuer may be able to update the user's cellular telephone number in the issuer database 108(b) even though the issuer 108 is not the authoritative source for cellular telephone numbers.

In some embodiments, risk module 102(b) will evaluate the risk involved in allowing an enrollment based on identification and transaction information about other users who are within the user's 104 household. For example, if a user 104 enrolls in a service for text message notifications of transactions, but the cellular telephone number provided does not match a device associated with the user 104, but does match a device owned by a member of the user's 104 household, the enrollment request may be allowed. Evaluating enrollment requests based on households will be described in further detail below.

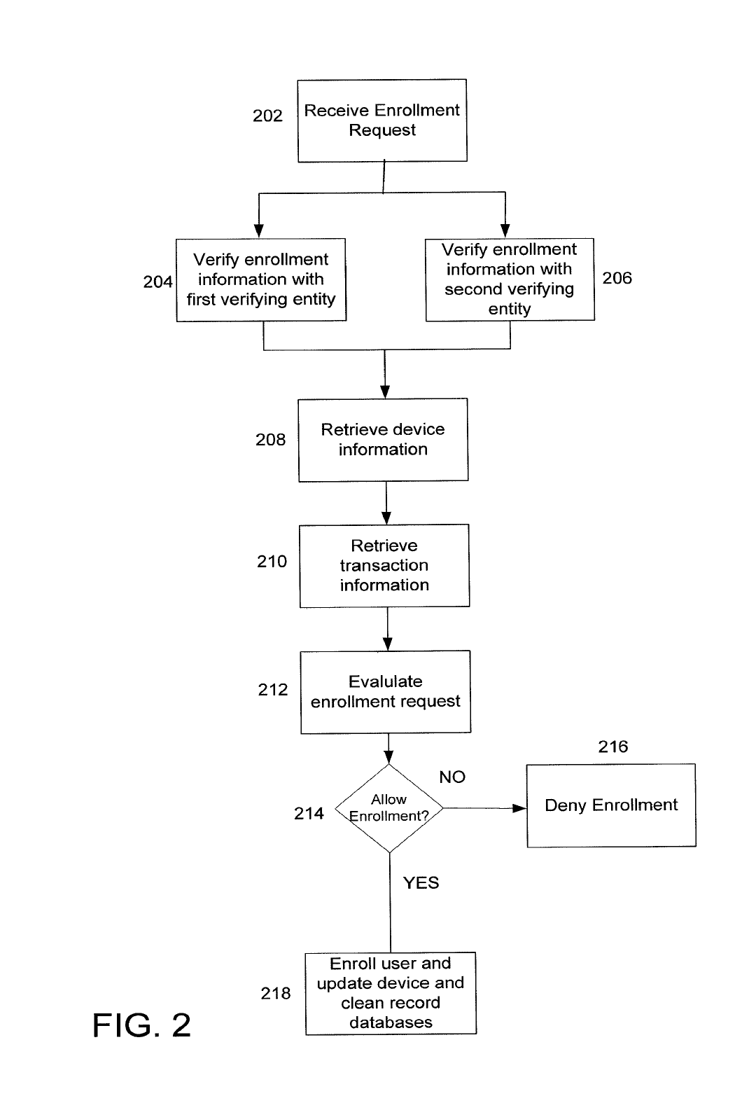

FIG. 2 depicts a high level flow diagram of an enrollment process in accordance with one embodiment of the disclosure.

At step 202 an enrollment server may receive an enrollment request from a user using a user access device. As has been discussed above, any number of user access devices may be suitable. The enrollment request may contain information that is necessary to enroll the user for a service. For example, the enrollment request may contain identification information, such as the user's name, address, account identifiers, device identifiers, or similar information.

At steps 204 and 206 the information provided in the enrollment request may be verified by entities that are capable of verifying the information provided in the enrollment request with authority. As depicted in FIG. 2, information in the enrollment request may be sent to more than one verifying entity. Steps 204 and 206 depict the information sent in the enrollment request being verified by two entities, however verification by any number of additional entities has been contemplated. In some embodiments, as many verifying entities as are required to completely verify all the information in the enrollment request may be utilized. As depicted in FIG. 2, verifying enrollment information with multiple verifying authorities may occur in parallel, such as to decrease the time necessary to perform the verification. In some embodiments, verification may occur in a serial fashion. In steps 204 and 206 the information present in the enrollment request may be evaluated to determine how closely it matches the information provided by the verifying entities. This information may be used in later evaluation steps. In some embodiments, information about the user's household will also be considered in addition to information about the user himself. Household information will be described in further detail below.

At step 208, device information may be retrieved. The device information may include information about the device being used to request enrollment, such as the user access device. The device information may also include information about a device that is being enrolled in the service, for example the telephone number of cellular telephone being enrolled for a text message notification service. In some embodiments, the device information is retrieved from the enrollment request itself. For example, a user enrolling for a service using his personal computer may send information in the enrollment request, such as an IP address of the personal computer, in the enrollment request. In some embodiments, the information regarding the device may be entered by the user. For example, a user may enter a cellular telephone number in the enrollment request. At step 208 device information may be evaluated to determine how closely the device information in the enrollment request matches device information that has been previously stored. This evaluation may be used in later evaluation steps.

At step 210, transaction information about the user may be retrieved. In some embodiments, a transaction database may contain a history of all transactions performed by the user. The user's transaction history may be evaluated to determine if the enrollment request fits within the profile of the user based on his past transactions. For example, a user who has never performed a balance transfer in the past, but is now enrolling for a balance transfer service may require additional scrutiny because the enrollment does not match the user's transactional behavior. Evaluation of a user's transaction history may be used in later evaluation steps.

At step 212 the user's enrollment request may be evaluated based on all of the evaluations performed in steps 204, 206, 208, and 210 to determine if the level of risk involved in allowing the enrollment request is acceptable. In some embodiments, in addition to the evaluations previously presented, external, third party evaluation services may also be employed. For example, a rating from an external credit rating agency may be used as an additional factor in determining if an enrollment request is allowed or denied. At step 214, the enrollment server may determine if allowing the enrollment request is too risky based on the previous evaluations. In some embodiments this determination may be made by determining a risk score based on the previous evaluations. If the enrollment request is determined to be too risky, the enrollment server may proceed to deny the enrollment request at step 216.

If the enrollment server has determined that the level of risk involved with allowing the enrollment request is acceptable, the enrollment server may allow the enrollment request at step 218. In addition to allowing the user to enroll for the requested service, the enrollment server may also update or create a clean record for the user containing all of the enrollment information that has been sufficiently verified. In addition, the enrollment sever may update or create device database records if the enrollment server was able to verify devices that are involved in the enrollment are actually associated with the user.

III. Exemplary Enrollment User Interface

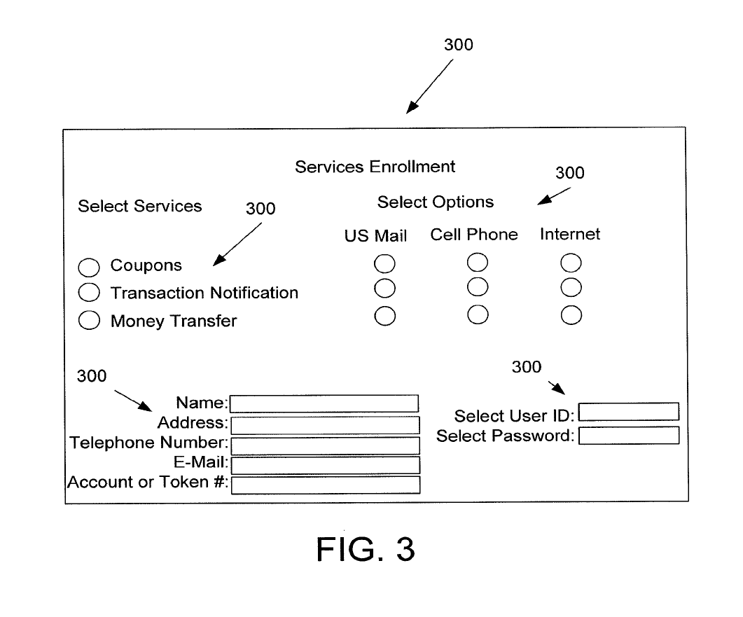

FIG. 3 depicts an exemplary user interface for enrollment requests. In some embodiments, the user interface 300 may be presented to a user access device in the form of a web page. In some embodiments, user interface 300 may allow a user to select services 310 in which he desires to enroll. For example, as depicted in user interface 300, a user may select to enroll in a coupon service, a transaction notification service, or a money transfer service. A coupon service may allow the user to receive discount coupons for various services or products. A transaction notification service may allow a user to receive notifications of transactions performed with his transaction account via a notification device, such as a cellular phone. A money transfer service may allow a user to transfer funds from one transaction account to another. Although three exemplary services have been depicted, any type of service for which an enrollment is required has been contemplated. In addition, although the exemplary services are related to transaction accounts, it should be clear that service enrollment is not limited to services related to transaction accounts. Furthermore it should be clear that although this exemplary user interface 300 displays multiple services, other embodiments may present a single service for enrollment.

User interface 300 may also allow a user to specify options 320 for the services in which he is enrolling. For example, for each of the exemplary services presented above, the user may be allowed to specify the device or access method he will use to access the service. Service options 320 may include US Mail, Cellular Phone, or the Internet. In some embodiments, each option may not be available for every service offered. For example, for a coupon or transaction notification service, US Mail delivery of the coupon or transaction notification may be acceptable. For a money transfer service however, US Mail may not be an acceptable option. For each offered service, the user may be presented with the options that apply to that service.

User interface 300 may also present the user with fields 330 to input information necessary to enroll for a service. For example, a user may be requested to enter his name, address, telephone number, e-mail address, and account or token number. Although this exemplary user interface 300 presents examples of the type of information that may be needed to enroll in a service, it is not intended to be exhaustive. A service may require additional information or may require less information than has been depicted. Any information that may be necessary for enrollment in a service or to identify the user may be included in the user interface 300.

In some embodiments, a user may also be requested to select a user id and password 340 as part of the enrollment process. The user id and password may be used for future modifications of the service. For example, if a user is currently enrolled in transaction text message notification to a cellular telephone, but then obtains a new cellular telephone, the user may need to update his enrollment information. The user id and password may provide additional information to the enrollment server in order to verify the identity of the user requesting changes to the service. As should be clear, the systems and methods described above would be applicable not only to a user requesting enrollment for a new service, but also for a user who is changing options related to a service in which he is already enrolled.

Once a user has entered all the information necessary for enrollment for a service into user interface 300, the information may be sent to the enrollment server to be processed as described above.

IV. Household

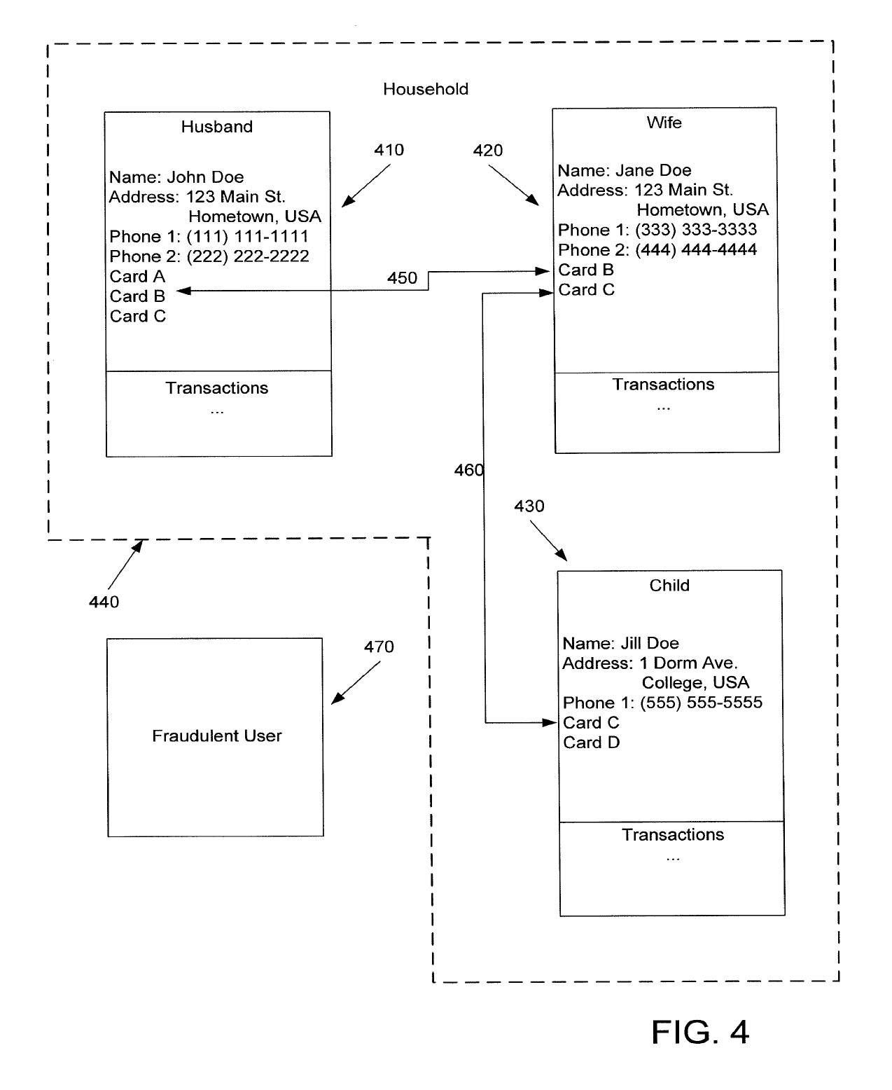

FIG. 4 depicts an exemplary household relationship. As mentioned above, in addition to using identification and transaction information related to the enrolling user, risk module 102(b) may also use identification and transaction information related to members of the enrolling user's household. The household may comprise a first user, as depicted by Husband 410. Husband 410 may have identifying information stored in a clean records database that contains verified information. Such information can include his name and address. Husband 410 may also have verified information, such as telephone numbers, stored in device database. Husband 410 may also have information, such as identifying information for transaction cards A, B, and C, as well as a transaction history associated with those transaction accounts. Although depicted as a single entity 410, it should be clear that this is for purposes of simplicity. The information stored about Husband 410 may be spread across any number of systems. The depiction in FIG. 4 is an abstract representation of information that is known about Husband 410, regardless of which specific systems actually store the information.

Likewise, Wife 420 may also have the same type of identifying information stored. Again, this information can include names, addresses, device information, transaction account information, and transaction historical information. Similarly, Child 430 may also have identifying information stored. A household 440 may be considered to be any set of users that are sufficiently related such that identifying information about one of the users may be applied to the other users in the set with a sufficiently low risk of fraud. In some embodiments, grouping users into a household may be specified in advance, while in other embodiments, a household may be determined by analyzing relationships amongst the various users.

For example, as depicted, Husband 410 and Wife 420 have several elements in common. They both share the same address, and in this example, they both share transaction cards B and C 450. Based on this information, the enrollment server may determine that Husband 410 and Wife 420 form at least part of a household. Furthermore, Child 430 is depicted as sharing some common identifying information with Wife 420. For example, Wife 420 and Child 430 share transaction card C 460. Based on this information, the enrollment server may determine that Child 430 also belongs to the same household as Husband 410 and Wife 420. As has been mentioned above, in some embodiments the enrollment server does not deduce the household relationships, but rather the relationship may be specified in advance. In addition, although the household relationship as presented appears to be related to a familial relationship, this is not intended to be limiting. Any grouping of users that are sufficiently related, either by definition or by deduction, may qualify as a household.

Embodiments of the disclosure as described above present a system wherein a user may request enrollment in a service. As part of that enrollment, the user may provide identifying information about himself. This information may be verified with verifying entities and further may be compared with the device being enrolled or used to perform the enrollment. In addition, the transaction history of the user may be analyzed to determine if the enrollment fits the transaction profile of the user. However, in some situations the information provided in an enrollment request may not be able to be verified for the user herself, but may be verifiable if an expanded set of users, such as those in the user's household are considered.

The use of a household in verifying enrollment requests may be better understood by way of the following example. Assume that Child 430 is the child of Husband 410 and Wife 420. Child 430 may have several transaction cards, such as cards C and D, however the bill for those transaction cards may be paid for by Husband 410 and Wife 420. As a condition of this arrangement, Husband 410 may wish to be notified of all transactions performed by Child 430. Child 430 may attempt to enroll in a transaction notification service that will send a text message to the telephone number associated with Husband 410. However, in accordance with embodiments of the disclosure as described above, this enrollment may fail because the telephone number that is associated with the enrollment request is not associated with child 430. As such, the enrollment server may deny the request because it can not determine if the request is legitimate, or is coming from a fraudulent user 470.

By utilizing the concept of a household, enrollment requests may be allowed even if the enrollment request does not exactly match information gathered about the enrolling user. In some embodiments, as long as the information can be verified as belonging to either the enrolling user, or a member of the enrolling user's household, the enrollment request may proceed.

By expanding verification of a user's enrollment request to members of the user's household, it may be possible to avoid unnecessarily denying enrollment requests. Unnecessarily denying enrollment requests may result in an increased level of enrollee frustration. In some cases, the enrollee may become frustrated to a sufficient degree that the enrollment attempt is abandoned altogether. Advantageously, embodiments of the present disclosure provide an alternative to denying enrollment. In cases where the user's information can not be verified directly, but does match information for others within the user's household, an enrollment server can make determinations based on the risk level involved with the enrollment. In some embodiments, the use of household information may be limited to enrollments that do not pose a high level of risk, while in other embodiments, household information may be used for all enrollment requests. The degree to which household information may be used in enrollment requests may be specified by the provider of the service for which enrollment is being requested.

Embodiments of the present disclosure advantageously allow an enrollment server to process an enrollment request in a secure manner. Information provided in the enrollment request may be verified by two or more verifying entities, each entity verifying portions of the information for which the entity is the authoritative source of the accuracy of the information. Furthermore, devices that are either being used to enroll in a service or are themselves being enrolled in the service may be verified to determine if the device is actually associated with the enrolling user. In addition, the transaction history of the user may be examined to determine if the enrollment request fits the transaction profile of the enrolling user. Finally, verification of the enrollee's information may be further expanded to include information about users in the enrollee's household, thus preventing denial of enrollment requests that have a sufficiently low risk of fraud.

V. Exemplary Devices

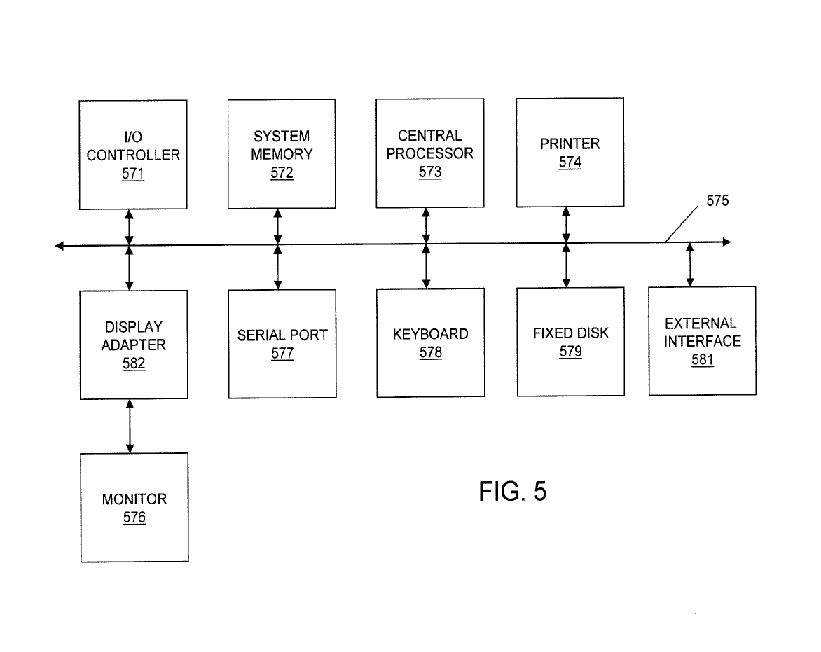

FIG. 5 shows typical components or subsystems of a computer apparatus. Such components or any subset of such components may be present in various components shown in FIG. 1, including the user access device 106, server computers 102, 110, 108, etc. The subsystems shown in FIG. 5 are interconnected via a system bus 575. Additional subsystems such as a printer 574, keyboard 578, fixed disk 579, monitor 576, which is coupled to display adapter 582, and others are shown. Peripherals and input/output (I/O) devices, which couple to I/O controller 571, can be connected to the computer system by any number of means known in the art, such as serial port 577. For example, serial port 577 or external interface 581 can be used to connect the computer apparatus to a wide area network such as the Internet, a mouse input device, or a scanner. The interconnection via system bus 575 allows the central processor 573 to communicate with each subsystem and to control the execution of instructions from system memory 572 or the fixed disk 579, as well as the exchange of information between subsystems. The system memory 572 and/or the fixed disk 579 may embody a computer readable medium. In some embodiments, the computer readable medium may comprise computer code for receiving an enrollment request at the enrollment server, the request including information identifying a requestor, computer code for sending at least a first portion of the identifying information to a first verifying entity, computer code for sending at least a second portion of the identifying information to a second verifying entity, computer code for receiving from the first verifying entity a first indication of the first portion of identifying information matching identifying information stored by the first verifying entity, computer code for receiving from the second verifying entity a second indication of the second portion of identifying information matching identifying information stored by the second verifying entity, computer code for comparing the enrollment request with a requestor's transaction history, the comparison indicating a degree to which the enrollment request matches the requestor's transaction history, and computer code for allowing or denying the enrollment request based on the first indication, the second indication, and the degree to which the enrollment request matches the requestor's transaction history.

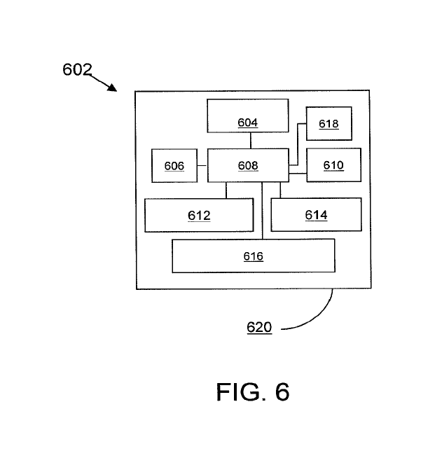

FIG. 6 depicts a portable consumer device. An exemplary portable consumer device, such as a cellular telephone, may be used to enroll for a service in some embodiments. In other embodiments, the portable consumer device itself may be enrolled in the service, for example to receive notifications.

An exemplary portable consumer device 602 in the form of a phone may comprise a computer readable medium and a body as shown in FIG. 6. FIG. 6 shows a number of components, and the portable wireless devices according to embodiments of the invention may comprise any suitable combination or subset of such components. The computer readable medium 606 may be present within the body 620, or may be detachable from it. The body 620 may be in the form a plastic substrate, housing, or other structure. The computer readable medium 606 may be a memory that stores data and may be in any suitable form including a magnetic stripe, a memory chip, encryption algorithms, private or private keys, etc. The memory also preferably stores information such as financial information, transit information (e.g., as in a subway or train pass), access information (e.g., as in access badges), etc. Financial information may include information such as bank account information, bank identification number (BIN), credit or debit card number information, account balance information, expiration date, consumer information such as name, date of birth, etc.

Information in the memory may also be in the form of data tracks that are traditionally associated with credits cards. Such tracks include Track 1 and Track 2. Track 1 (“International Air Transport Association”) stores more information than Track 2, and contains the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks must abide by it. It contains the cardholder's account, encrypted PIN, plus other discretionary data.

The portable wireless device 602 may further include a contactless element 618, which is typically implemented in the form of a semiconductor chip (or other data storage element) with an associated wireless transfer (e.g., data transmission) element, such as an antenna. Contactless element 618 is associated with (e.g., embedded within) portable consumer device 602 and data or control instructions transmitted via a cellular network may be applied to contactless element 618 by means of a contactless element interface (not shown). The contactless element interface functions to permit the exchange of data and/or control instructions between the mobile device circuitry (and hence the cellular network) and an optional contactless element 618.

Contactless element 618 is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable wireless device 602 and an interrogation device. Thus, the portable wireless device 602 is capable of communicating and transferring data and/or control instructions via both cellular network and near field communications capability.

The portable consumer device 602 may also include a processor 608 (e.g., a microprocessor) for processing the functions of the portable consumer device 602 and a display 610 to allow a consumer to see phone numbers and other information and messages. In some embodiments, the information and message received may be in response to services in which the user has enrolled. The portable wireless device 602 may further include input elements 612 to allow a consumer to input information into the device, a speaker 614 to allow the consumer to hear voice communication, music, etc., and a microphone 616 to allow the consumer to transmit her voice through the portable wireless device 602. The portable wireless device 602 may also include an antenna 604 for wireless data transfer (e.g., data transmission).

The specific details of the specific aspects of the present invention may be combined in any suitable manner without departing from the spirit and scope of embodiments of the invention. However, other embodiments of the invention may be directed to specific embodiments relating to each individual aspects, or specific combinations of these individual aspects.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. Computer programs incorporating features of the present invention may be encoded on various computer readable media for storage and/or transmission; suitable media include magnetic disk or tape, optical storage media such as compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive or an entire computer system), and may be present on or within different computer program products within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

1.-20. (canceled)

21. A computer implemented enrollment method comprising:
receiving , by an enrollment server computer from a user access device, an enrollment request to enroll in a notification service, wherein the enrollment request includes identifying information that identifies a requestor, wherein the information identifying the requestor comprises a name of the requestor, a transaction account identifier, and a cellular telephone number of the requestor;
verifying, by the enrollment server computer, an accuracy of the identifying information provided by the user access device, wherein the verifying the accuracy of the information comprises:
identifying, by the enrollment server computer, a first portion of the identifying information, wherein the first portion of the identifying information comprises the transaction account identifier; sending, by the enrollment server computer, the identified first portion of the identifying information to a first verifying entity computer, wherein the first verifying entity computer is an account issuer computer;
identifying, by the enrollment server computer, a second portion of the identifying information, wherein the second portion of the identifying information comprises the name of the requestor and the cellular telephone number of the requestor;
sending, by the enrollment server computer, the identified second portion of the information identifying the requestor to a second verifying entity computer, wherein the second verifying entity computer is a telecommunications carrier computer;
receiving, by the enrollment server computer from the first verifying entity computer, a first indication that the first portion of identifying information matches identifying information stored by the first verifying entity computer;
receiving, by the enrollment server computer from the second verifying entity computer a second indication that the second portion of identifying information matches identifying information stored by the second verifying entity computer;
verifying, by the enrollment server computer, based on the first indication received from the first verifying entity computer, that the transaction account identifier provided by the user access device is correct;
verifying, by the enrollment server computer, based on the second indication receiving from the second verifying entity computer, that the name of the requestor and the cellular telephone number of the requestor provided by the user access device is correct; after verifying the accuracy of the identifying information provided by the user access device, comparing, by the enrollment server computer, the enrollment request with a transaction history of the requestor;
determining, by the enrollment server computer, based on comparing the enrollment request with the transaction history of the requestor, whether the enrollment request fits a profile of requests of the requestor based on the transaction history of the requestor; and
allowing or denying the enrollment request based on whether the transaction account identifier provided by the user access device is verified, the name of the requestor and the cellular telephone number of the requestor is verified, and the enrollment request fits a profile of the requestor.

22. The method according to claim 21, wherein the sending the identified first portion of the identifying information to the first verifying entity computer is sent to the first verifying entity computer before the sending the identified second portion of the information identifying the requestor to the second verifying entity computer.

23. The method according to claim 21, wherein the identified first portion of the identifying information to the first verifying entity computer and the identified second portion of the information identifying the requestor to the second verifying entity computer are sent in parallel.

24. The method of claim 21, wherein the information identifying the requestor further comprises an expiration date for the transaction account identifier and a billing address of the requestor.

25. The method of claim 24, wherein the first portion of the identifying information further comprises the expiration date and the billing address.

26. The method of claim 21, wherein the account issuer computer is a bank computer.

27. The method of claim 21 further comprising:
generating a clean record of identifying information for the requestor, the clean record including at least portions of the identifying information that have been verified; and
storing the clean record in a clean record database.

28. The method of claim 27 further comprising:
providing an external interface to the clean record database to supply the clean record to external systems.

29. The method of claim 21, further comprising:
receiving device identification information from the requestor, the device identification information identifying the user access device;
comparing the received device identification information to device identification information stored in a device database; and
denying the enrollment request if the received device identification information and the stored device identification information are not the same.

30. The method of claim 21, further comprising:
receiving device identification information from the requestor, the device identification information identifying the user access device; and
storing the received device identification information in a device database if the received device identification information can be verified through the first verifying entity computer, the second verifying entity computer, or the transaction history of the requestor.

31. The method of claim 21, wherein the transaction history is updated in real time by a payment processing network.

32. The method of claim 21 wherein the transaction history of the requestor is updated in real time by a payment processing network, wherein the transaction history of the requestor is updated at substantially the same time as a transaction is performed, wherein the transaction history comprises credit or debit card transaction data.

33. An enrollment server computer comprising:
a processor; and
a non-transitory computer readable medium coupled to the processor, the non-transitory computer readable medium comprising code executable by the processor to implement a method comprising:
receiving, by the enrollment server computer from a user access device, an enrollment request to enroll in a notification service, wherein the enrollment request includes identifying information that identifies a requestor, wherein the information identifying the requestor comprises a name of the requestor, a transaction account identifier, and a cellular telephone number of the requestor;
verifying, by the enrollment server computer, an accuracy of the identifying information provided by the user access device, wherein the verifying the accuracy of the information comprises:
identifying, by the enrollment server computer, a first portion of the identifying information, wherein the first portion of the identifying information comprises the transaction account identifier; sending, by the enrollment server computer, the identified first portion of the identifying information to a first verifying entity computer, wherein the first verifying entity computer is an account issuer computer;
identifying, by the enrollment server computer, a second portion of the identifying information, wherein the second portion of the identifying information comprises the name of the requestor and the cellular telephone number of the requestor;
sending, by the enrollment server computer, the identified second portion of the information identifying the requestor to a second verifying entity computer, wherein the second verifying entity computer is a telecommunications carrier computer;
receiving, by the enrollment server computer from the first verifying entity computer, a first indication that the first portion of identifying information matches identifying information stored by the first verifying entity computer;
receiving, by the enrollment server computer from the second verifying entity computer a second indication that the second portion of identifying information matches identifying information stored by the second verifying entity computer;
verifying, by the enrollment server computer, based on the first indication received from the first verifying entity computer, that the transaction account identifier provided by the user access device is correct;
verifying, by the enrollment server computer, based on the second indication receiving from the second verifying entity computer, that the name of the requestor and the cellular telephone number of the requestor provided by the user access device is correct; after verifying the accuracy of the identifying information provided by the user access device, comparing, by the enrollment server computer, the enrollment request with a transaction history of the requestor;
determining, by the enrollment server computer, based on comparing the enrollment request with the transaction history of the requestor, whether the enrollment request fits a profile of requests of the requestor based on the transaction history of the requestor; and
allowing or denying the enrollment request based on whether the transaction account identifier provided by the user access device is verified, the name of the requestor and the cellular telephone number of the requestor is verified, and the enrollment request fits a profile of the requestor.

34. The enrollment server computer of claim 33, wherein a level of risk is assigned to the enrollment request.

35. The enrollment server computer of claim 33, wherein the method further comprises:
generating a clean record of identifying information for the requestor, the clean record including at least portions of the identifying information that have been verified, and
storing the clean record in a clean record database.

36. The enrollment server computer of claim 35, wherein the method further comprises:
providing an external interface to the clean record database to supply the clean record to external systems.

37. The enrollment server computer of claim 33, wherein the method further comprises:
receiving device identification information from the requestor, the device identification information identifying the user access device,
comparing the received device identification information to device identification information stored in a device database, and
denying the enrollment request if the received device identification information and the stored device identification information are not the same.

38. The enrollment server computer of claim 33, wherein the method further comprises:
receiving device identification information from the requestor, the device identification information identifying the user access device; and
storing the received device identification information in a device database if the received device identification information can be verified through the first verifying entity computer, the second verifying entity computer, or the transaction history requestor.

39. The enrollment server computer of claim 33, wherein the transaction history of the requestor is updated in real time by a payment processing network, wherein the transaction history of the requestor is updated at substantially the same time as a transaction is performed.

40. A system comprising:
an enrollment server computer comprising
a first processor, and
a first memory coupled with and readable by the first processor, the first memory configured to store a first set of instructions which, when executed by the first processor, causes the first processor to:
receive, by the enrollment server computer from a user access device, an enrollment request to enroll in a notification service, wherein the enrollment request includes identifying information that identifies a requestor, wherein the information identifying the requestor comprises a name of the requestor, a transaction account identifier, and a cellular telephone number of the requestor;
verify, by the enrollment server computer, an accuracy of the identifying information provided by the user access device, wherein the verifying the accuracy of the information comprises:
identify, by the enrollment server computer, a first portion of the identifying information, wherein the first portion of the identifying information comprises the transaction account identifier; send, by the enrollment server computer, the identified first portion of the identifying information to a first verifying entity computer, wherein the first verifying entity computer is an account issuer computer;
identify, by the enrollment server computer, a second portion of the identifying information, wherein the second portion of the identifying information comprises the name of the requestor and the cellular telephone number of the requestor;
send, by the enrollment server computer, the identified second portion of the information identifying the requestor to a second verifying entity computer, wherein the second verifying entity computer is a telecommunications carrier computer;
receive, by the enrollment server computer from the first verifying entity computer, a first indication that the first portion of identifying information matches identifying information stored by the first verifying entity computer;
receive, by the enrollment server computer from the second verifying entity computer a second indication that the second portion of identifying information matches identifying information stored by the second verifying entity computer;
verify, by the enrollment server computer, based on the first indication received from the first verifying entity computer, that the transaction account identifier provided by the user access device is correct;
verify, by the enrollment server computer, based on the second indication receiving from the second verifying entity computer, that the name of the requestor and the cellular telephone number of the requestor provided by the user access device is correct; after verifying the accuracy of the identifying information provided by the user access device, compare, by the enrollment server computer, the enrollment request with a transaction history of the requestor;
determine, by the enrollment server computer, based on comparing the enrollment request with the transaction history of the requester, whether the enrollment request fits a profile of requests of the requestor based on the transaction history of the requestor; and
allow or deny the enrollment request based on whether the transaction account identifier provided by the user access device is verified, the name of the requestor and the cellular telephone number of the requestor is verified, and the enrollment request fits a profile of the requestor.

41. The system of claim 40, wherein the first verification entity computer is coupled to the enrollment server computer, and wherein the second verification entity computer is coupled to the enrollment server computer.

42. The method of claim 40, further comprising, after a transaction is conducted, sending a notification to a cellular telephone associated with the cellular telephone number of the requestor.

43. The method of claim 42, wherein the notification sent to the cellular telephone is a text message including information about the transaction, and wherein the transaction is associated with the transaction account identifier.
